(19) United States
(12) Patent Application Publication
(10) Pub. No.: US 2011/0147074 A1
(43) Pub. Date: Jun. 23, 2011

(54) FIXING RACK FOR TELECOMMUNICATION APPARATUS AND MOUNTING METHOD THEREOF

(75) Inventors: YUNG-CHI CHENG, BADE CITY (TW); CHING-FENG HSIEH, TAIPEI CITY (TW)

(73) Assignee: ASKEY COMPUTER CORP., TAIPEI (TW)

(21) Appl. No.: 12/703,839

(22) Filed: Feb. 11, 2010

(30) Foreign Application Priority Data
Dec. 17, 2009 (TW) 098143441

(51) Int. Cl. H02B 1/40; B23P 19/04

(52) U.S. Cl. 174/480; 29/428; 29/525.02

(57) ABSTRACT

A fixing rack for a telecommunication apparatus allows the easy mounting, heat dissipation and maintenance of the telecommunication apparatus. A frame of the fixing rack is configured with a second hanging portion, a second joint portion and a fixing portion, wherein the fixing portion fixes the fixing rack on the installation surface, the second hanging portion hangs the telecommunication apparatus on the fixing rack with the first hanging portion configured on the back of the telecommunication apparatus, and the second joint portion joins with the first joint portion of the telecommunication apparatus and fixes the telecommunication apparatus on the fixing rack. The second hanging portion and the first hanging portion allow the telecommunication apparatus to be conveniently mounted onto the fixing rack. The fixing rack generates a gap between the telecommunication apparatus and the installation surface and facilitates heat dissipation and maintenance of the telecommunication apparatus.

### CROSS-REFERENCE TO RELATED APPLICATIONS

This non-provisional application claims priority under 35 U.S.C. §119(a) on Patent Application No(s). 098143441 filed in Taiwan, R.O.C. on 17 Dec. 2009, the entire contents of which are hereby incorporated by reference.

### FIELD OF THE INVENTION

The present invention relates to a fixing rack for a telecommunication apparatus and a mounting method thereof, and more particularly to a fixing rack facilitating mounting, heat dissipation and maintenance of the telecommunication apparatus.

### BACKGROUND OF THE INVENTION

Nowadays, the flow rate of information grows rapidly, resulting in the installation of a large amount of telecommunication apparatuses. FIG. 1 is a first schematic diagram showing a conventionally mounted telecommunication apparatus. As shown in the figure, during the mounting of the conventional telecommunication apparatus 7, the mounting structure 8 between the telecommunication apparatus 7 and the fixing location 9 is usually exposed outside, which makes the mounting structure 8 subject not only to the damage caused by the weather but also to the destruction and theft by thieves. FIG. 2 is a second schematic diagram showing another conventionally mounted telecommunication apparatus. As shown in the figure, during the mounting of another conventional telecommunication apparatus 71, the telecommunication apparatus 71 is usually adhered with the fixing location 91, which not only hinders heat dissipation of the telecommunication apparatus 71, but also introduces humidity from the fixing location 91 into the telecommunication apparatus 71, thereby breaking down the electronic components (not shown in the figure). Moreover, please refer to both FIG. 1 and FIG. 2. The mounting process of the telecommunication apparatuses 7, 71 described above usually requires at least two operators (not shown in the figure). When the telecommunication apparatus 7 or 71 is to be mounted onto the mounting structure 8 or the fixing location 9 or 91, first, one of the operators needs to place the telecommunication apparatus 7 or 71 stably on the mounting structure 8 or at the fixing location 9 or 91; next, another operator employs locking tools and locking elements to lock the telecommunication apparatus 7 or 71 on the mounting structure 8 or at the fixing location 9 or 91. Said mounting method is very inconvenient and labor-consuming.

Therefore, it is an object of the present invention to aggressively provide a method which allows easy mounting and maintenance and improved heat dissipation of a telecommunication apparatus.

### SUMMARY OF THE INVENTION

In view of the defects in the prior art, one object of the present invention is to provide a fixing rack for a telecommunication apparatus which allows easy mounting and maintenance and improved heat dissipation of the telecommunication apparatus.

Another object of the present invention is to provide a method of mounting a telecommunication apparatus, which uses a fixing rack to facilitate mounting, heat dissipation and maintenance of the telecommunication apparatus.

To achieve the objects described above, a first aspect of the present invention is a fixing rack for a telecommunication apparatus, which is applicable to mounting the telecommunication apparatus onto an installation surface. The back of a case of the telecommunication apparatus is configured with a first hanging portion and a first joint portion. The fixing rack comprises: a frame having a first surface, an opposite second surface, a fixing portion exposed from the second surface, and a second joint portion exposed from the first surface and corresponding to the first joint portion, the fixing portion being used to be fixed onto the installation surface, and the second joint portion being used to correspondingly join with the first joint portion; and a second hanging portion, which is configured on the first surface for correspondingly positioning and hanging of the first hanging portion.

To achieve the objects described above, a second aspect of the present invention is a method of mounting a telecommunication apparatus, which is applicable to mounting the telecommunication apparatus onto an installation surface. The back of a case of the telecommunication apparatus is configured with a first hanging portion and a first joint portion. The method includes the following steps:

providing a fixing rack comprising a frame and a second hanging portion, the frame having a first surface, an opposite second surface, a fixing portion exposed from the second surface, and a second joint portion exposed from the first surface and corresponding to the first joint portion, the second hanging portion being configured on the first surface;

configuring the fixing rack against the installation surface and fixing the fixing rack onto the installation surface through the fixing portion;

positioning and hanging the telecommunication apparatus onto the second hanging portion through the first hanging portion; and,

correspondingly joining the second joint portion with the first joint portion to fix the telecommunication apparatus with the fixing rack.

Thus, the fixing rack for a telecommunication apparatus and the mounting method according to the present invention employ the second hanging portion and the first hanging portion to make the fixing rack easily mountable with the telecommunication apparatus; in addition, a gap is generated between the telecommunication apparatus and the installation surface by the fixing rack to facilitate heat dissipation and easy maintenance of the telecommunication apparatus.

### BRIEF DESCRIPTION OF THE DRAWINGS

FIG. 1 is a first schematic diagram showing a conventionally mounted telecommunication apparatus;

FIG. 2 is a second schematic diagram showing a conventionally mounted telecommunication apparatus;

FIG. 3 is a first front view of a fixing rack of a preferred embodiment according to the present invention;

FIG. 4 is a first rear view of a fixing rack of a preferred embodiment according to the present invention;

FIG. 5 is a second rear view of a fixing rack of a preferred embodiment according to the present invention;

FIG. 6 is a second front view of a fixing rack of a preferred embodiment according to the present invention;

FIG. 7 is a third front view of a fixing rack of a preferred embodiment according to the present invention;

FIG. 8 is a schematic diagram of mounting a fixing rack with a telecommunication apparatus in a preferred embodiment according to the present invention;

FIG. 9 is a first schematic diagram of a hung telecommunication apparatus in a preferred embodiment according to the present invention;

FIG. 10 is a side view for hanging of a hung telecommunication apparatus in s preferred embodiment according to the present invention; and,

FIG. 11 is a second schematic diagram of a hung telecommunication apparatus in a preferred embodiment according to the present invention.

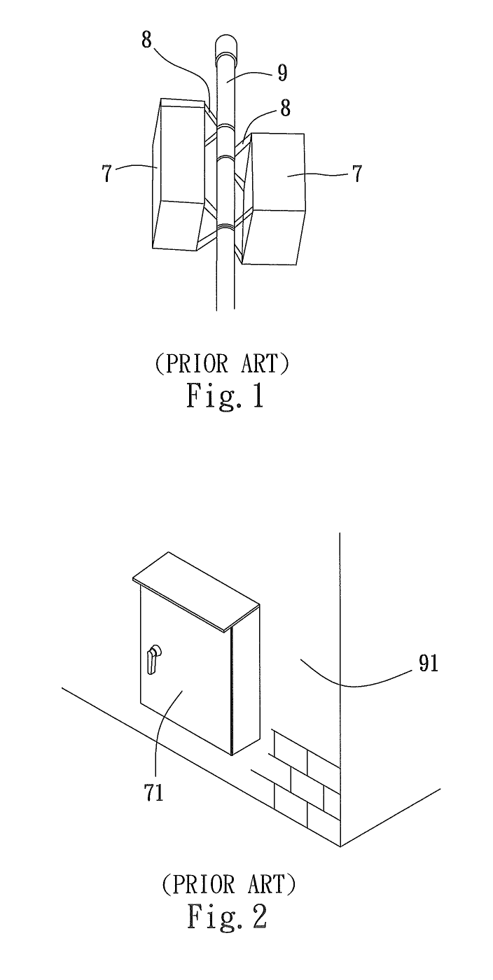

### DETAILED DESCRIPTION OF PREFERRED EMBODIMENTS

To fully understand the objects, features and effects of the present invention, the present invention is described in details with the following embodiments in conjunction with the attached figures as follows.

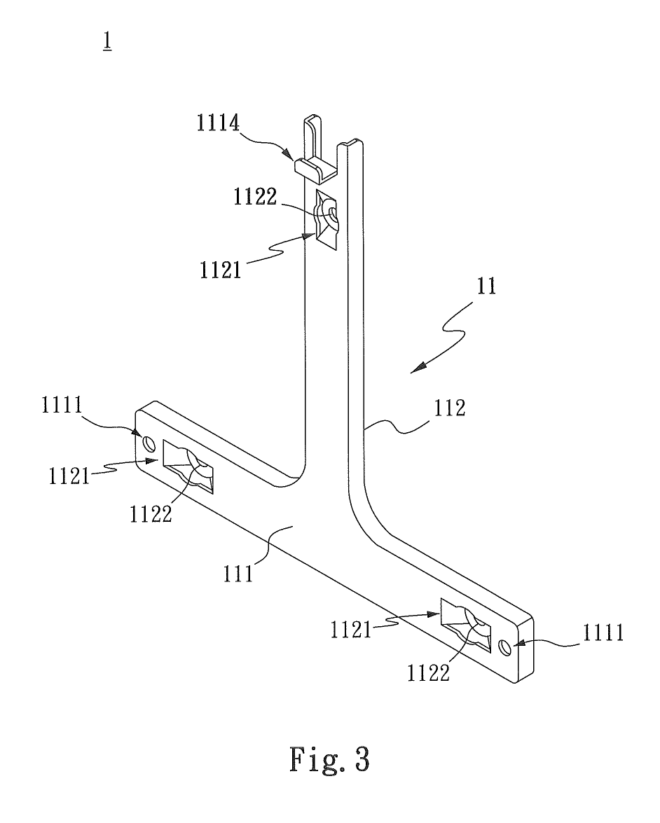

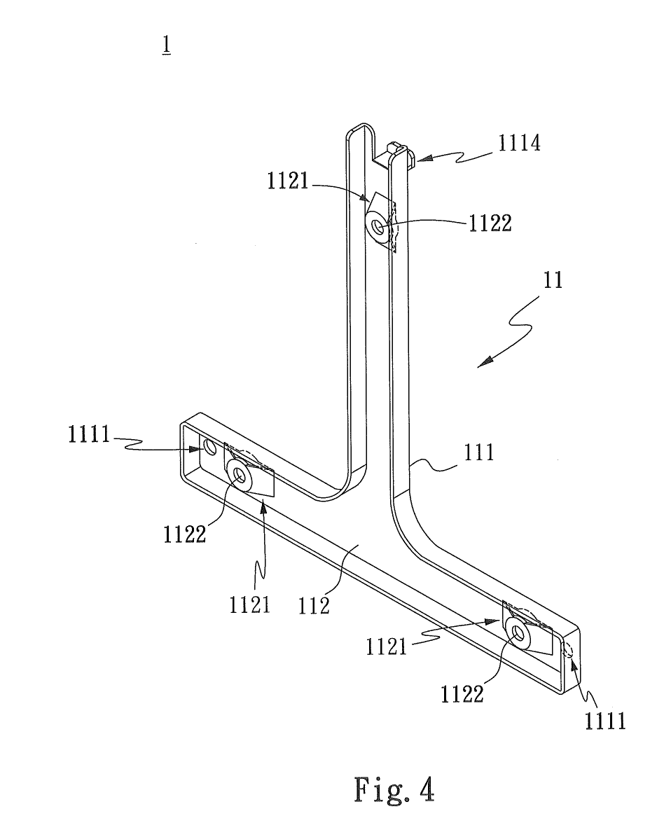

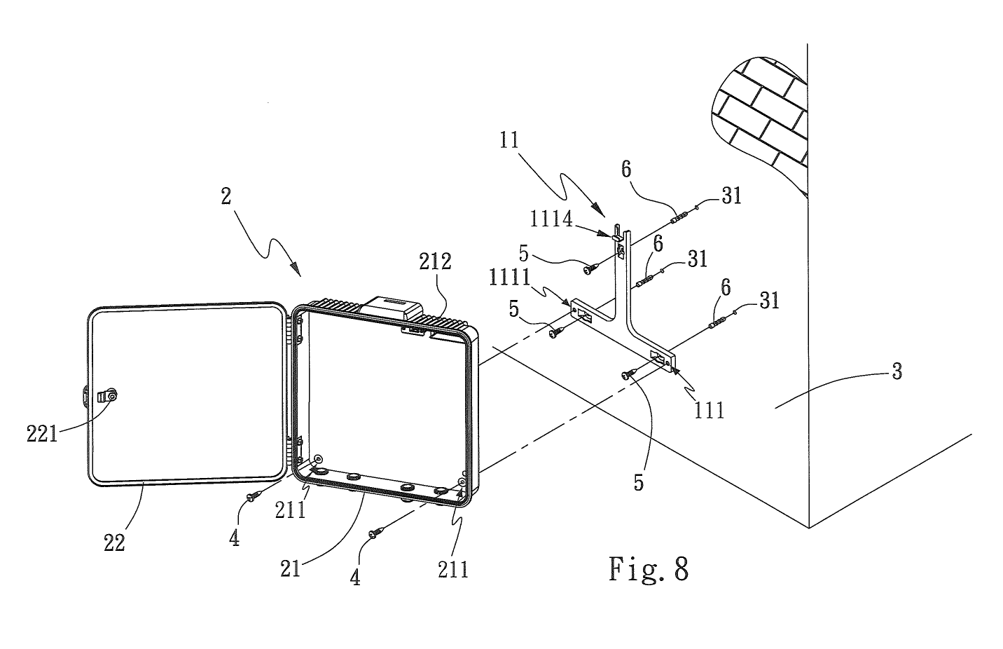

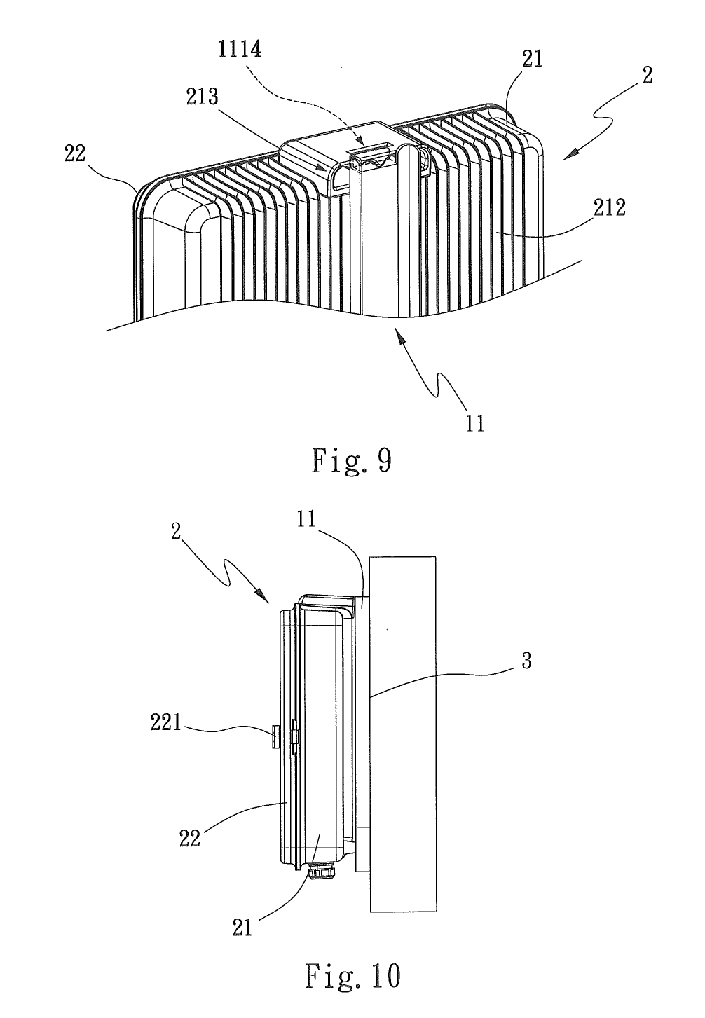

FIG. 3 and FIG. 4 show respectively the first front view and the first rear view of the fixing rack in a preferred embodiment according to the present invention. Please also refer to FIG. 8 and FIG. 9, which show respectively the schematic diagram of mounting a fixing rack with a telecommunication apparatus and a first schematic diagram of a hung telecommunication apparatus in a preferred embodiment according to the present invention. As shown in the figures, the first aspect of the present invention provides a fixing rack 1 for a telecommunication apparatus, which is applicable to mounting a telecommunication apparatus 2 onto an installation surface 3, such as a wall surface. The back of the case of the telecommunication apparatus 2 is configured with a first hanging portion 213 and at least one first joint portion 211. The fixing rack 1 comprises a frame 11 and a second hanging portion 1114, wherein the frame 11 has a first surface 111, a second surface 112 opposite thereto, at least one fixing portion 1121 exposed from the second surface 112, and at least one second joint portion 1111 exposed from the first surface 111 and corresponding to the first joint portion 211. One side of the fixing rack 1 toward the installation surface 3 may be hollow (shaped by punching) to reduce the weight and save material cost. The fixing portion 1121 is used to be fixed onto the installation surface 3. The second joint portion 1111 is used to correspondingly join with the first joint portion 211; the second hanging portion 1114 is configured on the first surface 111 for correspondingly positioning and hanging of the first hanging portion 213. The fixing rack 1 for the telecommunication apparatus 2 according to the present invention can first employ the fixing portion 1121 to fix the fixing rack 1 onto the installation surface 3; then the first hanging portion 213 on the back of the telecommunication apparatus 2 is used to hang the telecommunication apparatus 2 on the second hanging portion 1114 of the fixing rack 1; finally, the first joint portion 211 of the telecommunication apparatus 2 is joined with the second joint portion 1111 of the fixing rack 1 to complete the mounting. The above-mentioned mounting process employs the second hanging portion 1114 and the first hanging portion 213 to conveniently mount the telecommunication apparatus 2 onto the fixing rack 1 and to generate a gap between the telecommunication apparatus 2 and the installation surface 3 through the fixing rack 1 to allow good heat dissipation and easy maintenance of the telecommunication apparatus 2.

The aforesaid fixing portion 1121 comprises a plurality of through-holes 1122 penetrable by fixing components such that the fixing rack 1 can be fixed onto the installation surface 3 after a plurality of fixing components are penetrated through the through-holes 1122 of the fixing portion 1121.

The aforesaid fixing portion 1121 has a plurality of bridge-like structures. The bridge-like structures can be formed by punching the frame 11, and the through-holes 1122 can be configured in the bridge-like structures by drilling.

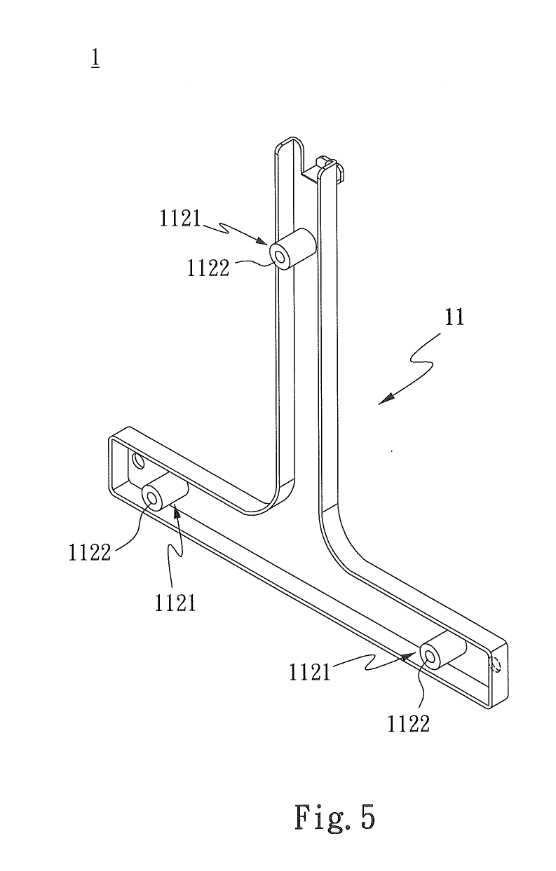

FIG. 5 is a second rear view of a fixing rack in a preferred embodiment according to the present invention. As shown in the figure, the aforesaid fixing portion 1121 may have a plurality of column-like structures. The column-like structures can be formed before joined with the frame 11, and the through-holes 1122 may be configured in the column-like structures by drilling.

The aforesaid fixing components 4, 5 may be screws or bolts.

The second joint portion 1111 may comprise at least one screw hole, and the first joint portion 211 comprises a corresponding number of through-holes penetrable by screws or bolts such that the first joint portion 211 and the second joint portion 1111 can be combined after having screws or bolts penetrated through the through-holes and engaged with the screw holes.

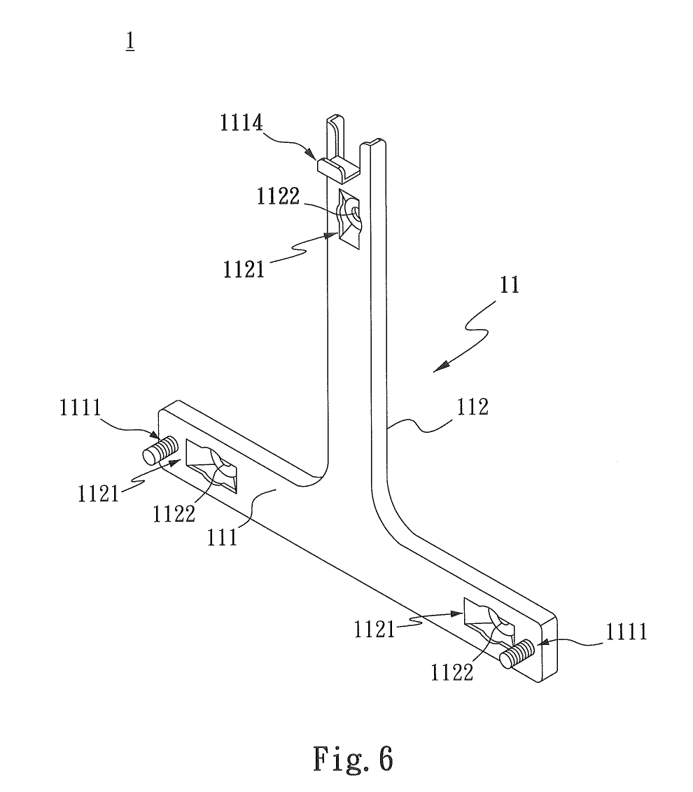

FIG. 6 is a second front view of a fixing rack in a preferred embodiment according to the present invention. As shown in the figure, the second joint portion 1111 comprises at least one bolt protruded from the first surface 111, and the first joint portion 211 comprises a corresponding number of through-holes penetrable by the bolt and lockable by the nuts, such that the first joint portion 211 is joined with the second joint portion 1111 after the bolt is penetrated through the through-holes and engaged with the nuts.

The second hanging portion 1114 may be a hook protruded from the first surface 111, and the first hanging portion 213 is a corresponding opening structure such that the first hanging portion 213 and the second hanging portion 1114 can be joined by hanging the opening onto the hook.

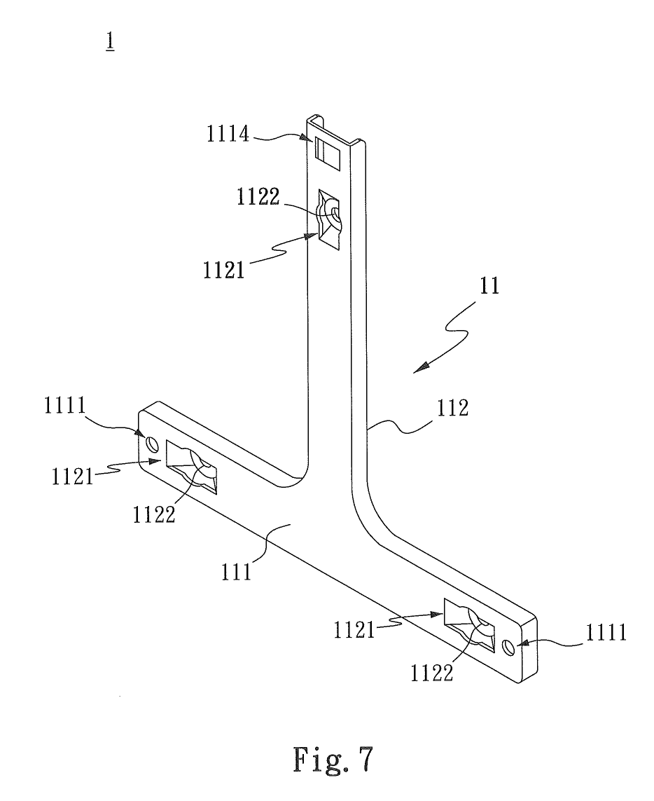

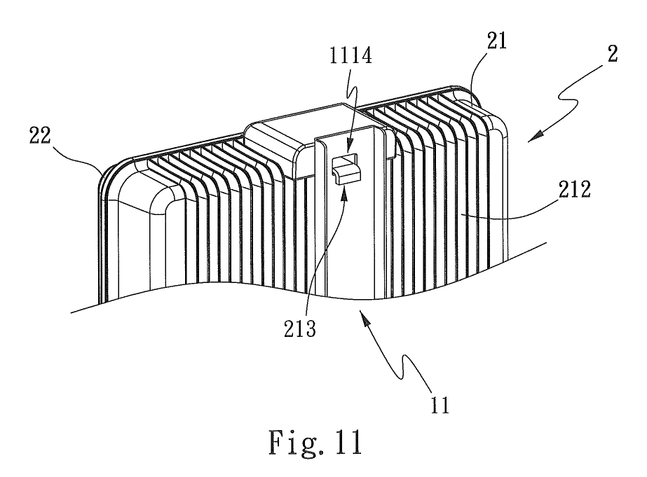

FIG. 7 is a third front view of a fixing rack in a preferred embodiment according to the present invention. Please also refer to FIG. 11, which is a second schematic diagram of a hung telecommunication apparatus in a preferred embodiment according to the present invention. As shown in the figure, the second hanging portion 1114 may be an opening structure configured on the first surface 111, and the first hanging portion 213 is a hook correspondingly protruded from the back of the case, such that the first hanging portion 213 and the second hanging portion 1114 can be joined by hanging the hook at the opening.

The aforesaid frame 11 may be inversed T-shaped, and the second hanging portion 1114 is near the top end. The T-shaped frame 11 cannot only save the material cost and reduce the weight of the fixing rack 1, but also increase the spacing between the telecommunication apparatus 2 and the installation surface 3 for air flow to improve the efficiency of heat dissipation.

Furthermore, please again refer to FIG. 8. As shown in the figure, when the aforesaid through-holes 1122 (not shown in FIG. 8) fix the fixing rack onto the installation surface 3, a plurality of bushings 6 can be first buried within a plurality of fixing holes 31 on the installation surface 3; then, after penetrating a plurality of fixing components 5 through the through-holes 121 of the fixing rack, the fixing components 5 can be engaged with the fixing holes 31 of the installation surface 3. These fixing components 5 may be inflatable screws. Moreover, a cover 22 of the telecommunication apparatus 2 can be locked with a cabinet 21 of the telecommunication apparatus 2 through a lock 221.

As shown in FIGS. 3, 4, 8, 9 and 10, the second aspect of the present invention provides a method of mounting a telecommunication apparatus, which is applicable to mounting the telecommunication apparatus 2 onto an installation surface 3. The back of the case of the telecommunication apparatus 2 is configured with a first hanging portion 213 and at least one first joint portion 211. The method includes the following steps:

providing a fixing rack 1 comprising a frame 11 and a second hanging portion 1114; the frame 11 has a first surface 111, an opposite second surface 112, at least one fixing portion 1121 exposed from the second surface 112, and at least one second joint portion 1111 exposed from the first surface 111 and corresponding to the first joint portion 211; the second hanging portion 1114 is configured on the first surface 111;

configuring the fixing rack 1 against the installation surface 3 and fixing the fixing rack 1 on the installation surface 3 through the fixing portion 1121;

positioning and hanging the telecommunication apparatus 2 onto the second hanging portion 1114 through the first hanging portion 213; and,

correspondingly joining the second joint portion 1111 with the first joint portion 211 to fix the telecommunication apparatus 2 with the fixing rack 1.

The aforesaid fixing portion 1121 comprises a plurality of through-holes 1122 and fixes the fixing rack 1 onto the installation surface 3 by having the fixing components 5 penetrated through the through-holes 1122.

The above-mentioned second hanging portion 1114 may be a hook protruded from the first surface 111, and the first hanging portion 213 is a corresponding opening structure, such that the first hanging portion 213 and the second hanging portion 1114 can be joined by hanging the opening on the hook.

As shown in FIG. 11, the aforesaid second hanging portion 1114 may be an opening structure configured on the first surface 111, and the first hanging portion 213 may be a hook correspondingly protruded from the back of the case, such that the first hanging portion 213 can be joined with the second hanging portion 1114 by hanging the hook at the opening.

The aforesaid second joint portion 1111 comprises at least one screw hole, and the first joint portion 211 comprises a corresponding number of through-holes, such that the screws or bolts penetrating through the through-holes can be joined with the screw hole to fix the telecommunication apparatus 2 with the fixing rack 1.

As shown in FIG. 6, the aforementioned second joint portion 1111 comprises at least one bolt protruded from the first surface 111, and the first joint portion comprises a corresponding number of through-hole; after penetrating the bolt through the through-hole and locking the bolt with a nut, the telecommunication apparatus 2 can be fixed with the fixing rack 1, wherein the first joint portion can be joined with the second joint portion 1111 by penetrating the bolt through the through-hole and locking the bolt with nuts.

The fixing rack 1 may be T-shaped (or H-shaped, U-shaped, V-shaped, Y-shaped, or other symmetrically shaped with hollow peripheries), and the T-shaped fixing rack 1 is configured upside down. The second hanging portion 1114 may be configured at one end of the vertical portion of the fixing rack 1. The design of T-shaped fixing rack 1 not only saves the material usage, but also increases the gap space between the telecommunication apparatus 2 and the installation surface 3 for facilitating the heat dissipation.

With the fixing rack 1 according to the present invention, a gap is generated between the back of the telecommunication apparatus 2 and the installation surface 3 to facilitate the heat dissipation of the telecommunication apparatus 2, and particularly, the back of the telecommunication apparatus 2 is configured with a plurality of cooling fins 212 to prevent the humidity on the installation surface 3 from entering into the telecommunication apparatus 2 and thereby preventing damage of electronic components (not shown in the figure), achieving the purpose of maintaining the telecommunication apparatus 2; furthermore, the telecommunication apparatus 2 and the fixing rack 1 are stacked on the installation surface 3, such that the telecommunication apparatus 2 can cover the fixing components 5 after locked with the lock 221. The fixing components 4 can be configured inside the telecommunication apparatus 2, so that the thieves cannot dismount the fixing components 4 and the fixing components 5 and steal the telecommunication apparatus 2, thereby achieving the burglarproof purpose.

The design of the second hanging portion 1114 enables the telecommunication apparatus 2 to be hung first and then locked by only one operator, which can eliminate the inconvenience that another operator has to hold the telecommunication apparatus 2 before locking the telecommunication apparatus 2, and improve the efficiency of mounting the telecommunication apparatus 2.

As described above, the present invention employs the second hanging portion 1114 of the fixing rack 1 and the first hanging portion 213 of the telecommunication apparatus 2 to achieve easy mounting of the telecommunication apparatus 2; moreover, the present invention employs the fixing rack 1 to generate a gap between the telecommunication apparatus 2 and the installation surface 3 to achieve the purpose of heat dissipation and maintenance of the telecommunication apparatus 2.

The present invention has been disclosed in the context with preferred embodiments. However, person skilled in the art should appreciate that these embodiments are only used to describe the present invention and are not a limitation on the scope of the present invention. It should be noted that all the equivalent variances and replacement on the embodiments should be within the scope of the present invention. Thus, the claimed scope of the present invention should be defined by the attached claims below.

What is claimed is:

1. A fixing rack, which is configured for mounting a telecommunication apparatus onto an installation surface, the back of a case of the telecommunication apparatus being configured with a first hanging portion and a first joint portion, the fixing rack comprising:
a frame, which has a first surface, an opposite second surface, a fixing portion exposed from the second surface, and a second joint portion exposed from the first surface and corresponding to the first joint portion, the fixing portion being used to be fixed onto the installation surface, and the second joint portion being used to correspondingly join with the first joint portion; and,
a second hanging portion, which is configured on the first surface for correspondingly positioning and hanging of the first hanging portion.

2. The fixing rack according to claim 1, wherein the fixing portion comprises a plurality of through-holes penetrable by fixing components.

3. The fixing rack according to claim 2, wherein the fixing portion comprises a plurality of bridge-like structures, and the through-holes are configured within the bridge-like structures.

4. The fixing rack according to claim 2, wherein the fixing portion comprises a plurality of column-like structures, and the through-holes are configured within the column-like structures.

5. The fixing rack according to claim 2, wherein the fixing components are screws or bolts.

6. The fixing rack according to claim 1, wherein the second joint portion comprises at least one screw hole, and the first joint portion comprises a corresponding number of through-hole penetrable by screws or bolts.

7. The fixing rack according to claim 1, wherein the second joint portion comprises at least one bolt protruded from the first surface, and the first joint portion comprises a corresponding number of through-hole penetrable by the bolt and lockable by nuts.

8. The fixing rack according to claim 1, wherein the second hanging portion comprises a hook protruded from the first surface, and the first hanging portion comprises a corresponding opening structure.

9. The fixing rack according to claim 1, wherein the second hanging portion comprises an opening structure configured on the first surface, and the first hanging portion comprises a hook correspondingly protruded from the back of the case.

10. The fixing rack according to claim 1, wherein the frame is inverse T-shaped, and the second hanging portion is near the top end.

11. A method of mounting a telecommunication apparatus, which is applicable to mounting the telecommunication apparatus onto an installation surface, the back of a case of the telecommunication apparatus being configured with a first hanging portion and a first joint portion, the method including the following steps:
providing a fixing rack comprising a frame and a second hanging portion, the frame having a first surface, an opposite second surface, a fixing portion exposed from the second surface, and a second joint portion exposed from the first surface and corresponding to the first joint portion, the second hanging portion being configured on the first surface;
configuring the fixing rack against the installation surface and fixing the fixing rack on the installation surface through the fixing portion;
positioning and hanging the telecommunication apparatus onto the second hanging portion through the first hanging portion; and,
correspondingly joining the second joint portion with the first joint portion to fix the telecommunication apparatus with the fixing rack.

12. The method according to claim 11, wherein the fixing portion comprises a plurality of through-holes penetrable by fixing components to fix the fixing rack onto the installation surface.

13. The method according to claim 11, wherein the second hanging portion comprises a hook protruded from the first surface, and the first hanging portion comprises a corresponding opening structure.

14. The method according to claim 11, wherein the second hanging portion comprises an opening structure configured on the first surface, and the first hanging portion comprises a hook correspondingly protruded from the back of the case.

15. The method according to claim 11, wherein the second joint portion comprises at least one screw hole, and the first joint portion comprises a corresponding number of through-hole, such that the screw hole and the through-hole are penetrable by screws or bolts to fix the telecommunication apparatus with the fixing rack.

16. The method according to claim 11, wherein the second joint portion comprises at least one bolt protruded from the first surface, and the first joint portion comprises a corresponding number of through-hole penetrable by the bolt and lockable by nuts to fix the telecommunication apparatus with the fixing rack.
